(19) United States
(12) Patent Application Publication
(10) Pub. No.: US 2009/0037240 A1
(43) Pub. Date: Feb. 5, 2009

(54) Joint Tracking and Tracing and Business Activity Monitoring

(76) Inventors: Patrick Schmidt, Heilsberg (DE); Matthias Jensen, Walldorf (DE); Petra Diessner, Karlsruhe (DE)

Correspondence Address: MINTZ, LEVIN, COHN, FERRIS, GLOVSKY & POPEO, P.C., ONE FINANCIAL CENTER, BOSTON, MA, 02111, US

(21) Appl. No.: 11/833,946

(22) Filed: Aug. 3, 2007

(51) Int. Cl. G06Q 10/00

(52) U.S. Cl. 705/7

(57) ABSTRACT

A system and method for executing a business application that comprises a number of monitoring events and a number of monitoring processes corresponding to a number of supply chain events of the supply chain. Tracking and tracing data for the number of supply chain events is generated with one or more RFID readers of an RFID platform. The tracking and tracing data for the number of supply chain events is then mapped against a set of the number of monitoring events and the number of monitoring processes defined for the business application, to monitor performance of the supply chain and business application.

### BACKGROUND

This disclosure relates generally to computer-based mechanisms for monitoring activity of a business application, and more particularly to techniques for joint tracking and tracing of business application activity.

A business process is a set of coordinated tasks and activities, conducted by both people and computers, that accomplishes a specific business or organizational task. Business activity monitoring (BAM) is a framework that enables users to act on significant business events, take informed actions in a particular work context, and to monitor, measure, and improve the efficiency of the business process. BAM is a fundamental change from the conventional reactive, report-driven enterprise.

In a services oriented architecture (SOA), which is a structure to support communications among units of work (i.e. “enterprise services”) executing on behalf of computing entities such as a group of users or applications, key functions that are needed are tracking and tracing of business processes within each service. For instance, SAP AG of Walldorf Germany provides a SOA in the form of an Enterprise Services Architecture (ESA) to facilitate deployment of Web-based enterprise services at the business level. SAP's ESA can use an Agent Framework (AF) to execute the enterprise services in or on top of a Business Process Platform (BPP).

A fundamental premise of ESA and other OSAs is the abstraction of business activities or events, modeled as enterprise services, from the actual functionality of enterprise applications. However, there exists in conventional BAM frameworks a large gap between the modeling of business activities and the execution of tracking and tracing of tangible materials and products across an enterprise supply chain.

In an era of changing and uncertain economic conditions and relentless competition, most company decision makers look for ways to optimize their supply chain network. Such optimization is the key to cutting costs, increasing revenue, and reducing working and fixed capital. One form of optimization that has been implemented lately is the use of RFID technology, which enables the noncontact identification, control, tracking and tracing of goods and items throughout supply chain. Many suppliers have made significant investments in RFID tags, readers, and hardware and software infrastructures.

The move to RFID has been challenging in many ways. For one thing, standards for the technology are still evolving; for another, RFID strategies and approaches vary from one organization to the next, and even within an organization. Analysts predict that RFID integration may result in a ten to fifteen-fold increase in data volume. Such volumes lead to high costs for maintaining multiple interfaces between RFID and data warehouse management, enterprise resource planning (ERP), and business process management.

### SUMMARY

In general, this document discusses a tracking and tracing system integrated with a business activity monitoring system. Accordingly, this document discloses a software architecture that can encompass current and future tracking and tracing and BAM technology, combined with a data architecture that enables an enterprise to manage massive amounts of data at a low total cost of ownership.

In one aspect, a business supply chain monitoring system includes a server. The server provides a business activity monitoring platform that maps, against monitoring events and monitoring processes defined for a business application that controls a supply chain, tracking and tracing data provided by an RFID platform for a number of supply chain events of the supply chain.

In another aspect, a business supply chain monitoring system includes a computer system implementing a business application including a number of monitoring events and a number of monitoring processes corresponding to a number of supply chain events of the supply chain. The system further includes an RFID platform having one or more RFID readers, at least one RFID reader being assigned to a supply chain event to generate tracking and tracing data for the number of supply chain events. The system further includes a business activity monitoring platform that maps the tracking and tracing data for the number of supply chain events against a set of the number of monitoring events and the number of monitoring processes defined for the business application, to monitor performance of the supply chain and business application.

In yet another aspect, a method of monitoring a business supply chain includes steps of executing a business application that comprises a number of monitoring events and a number of monitoring processes corresponding to a number of supply chain events of the supply chain. The method further includes generating tracking and tracing data for the number of supply chain events with one or more RFID readers of an RFID platform, and mapping the tracking and tracing data for the number of supply chain events against a set of the number of monitoring events and the number of monitoring processes defined for the business application, to monitor performance of the supply chain and business application.

The details of one or more embodiments are set forth in the accompanying drawings and the description below. Other features and advantages will be apparent from the description and drawings, and from the claims.

### BRIEF DESCRIPTION OF THE DRAWINGS

These and other aspects will now be described in detail with reference to the following drawings.

FIG. 1 is a block diagram of a business application system and business activity monitoring and evaluation system.

FIG. 2 depicts an operational process of a supply chain system.

FIG. 3 is a functional block diagram of a business process deployment system.

FIG. 4 is a functional block diagram of a joint tracking and tracing system for business activity monitoring.

Like reference symbols in the various drawings indicate like elements.

### DETAILED DESCRIPTION

This document describes a joint tracking and tracing (T&T) and business activity monitoring (BAM) system and method that deepens the integration of business intelligence capabilities into the overall handling and extraction of data. This can enhance event management and enable a more detailed extraction and analysis of data across different auto-ID infrastructures and business partners.

Business activity monitoring (BAM) refers to the collection, analysis, and delivery of relevant and timely data about business activities within an enterprise, as well as those activities that involve customers and business partners of an enterprise. In particular, BAM is used to monitor the electronic interaction among the computing systems of such enterprises, customers and business partners.

In accordance with some implementations, monitoring processes are explicitly modeled. There can be more than one monitoring process for each operational process, however, monitoring processes are decoupled from operational processes. Each monitoring process consists of rules and conditions (e.g. based on measurements), that are not reflected in operational processes. Objects that are not covered by an operational process, such as external status, physical objects, etc., are made visible. Monitoring processes are preferably created by business experts to reflect a certain aspect of an operational process that is not reflected in its implementation. Group-specific monitoring processes are desirably targeted. Event management (EM) combines the statistics of multiple event handlers and sends this as the status of the preceding document to the document flow.

In implementations of the system and method, a monitoring event is a notification by a monitoring process about a significant state change in the business application system. For example, in SAP's Exchange Infrastructure (XI), the transport medium of monitoring events are XI messages, and the transport mechanism is the XI messaging infrastructure. BAM enriches the scenario of event resolution with stateful processes and correlation of monitoring events.

An application can discharge monitoring events using message communication, and therefore a monitoring event also represents a message interface that refers to message type, etc. Each already existing message communication can be used to supply monitoring processes with information. Additional monitoring events are necessary when no message communication exists already.

Workflow events can be used to enable application systems to fire monitoring events to eventually produce an event resolution. Event resolution in a basic sense means that an application detects invalid business data or some deadline that has been reached in a workflow event, and an alert is dispatched. This alert will be used by an event resolution framework (i.e. an Event Resolution Center, or “ERC”) to generate a resolution to the workflow event. Thus, the application alone must be able to detect the inconsistent or incorrect state of the application data. In some cases, the application will not be able to detect such inconsistencies because it may need additional data from other systems, or because one monitoring event alone does not lead to an alert that is visible to an end-user.

Workflow events are created at various points of an enterprise application. They can be created directly by the application, or via “generic event enablers” such as business transaction events (BTEs), message control (NAST), a post-processing framework (PPF), change documents, a logistics information system, and change of personnel data related to the enterprise. In accordance with embodiments of a joint tracking and tracing and BAM solution, workflow events are used as an enabler for monitoring of applications employed by an enterprise, and a workflow event infrastructure is used to enable execution and monitoring of applications without modification to those applications.

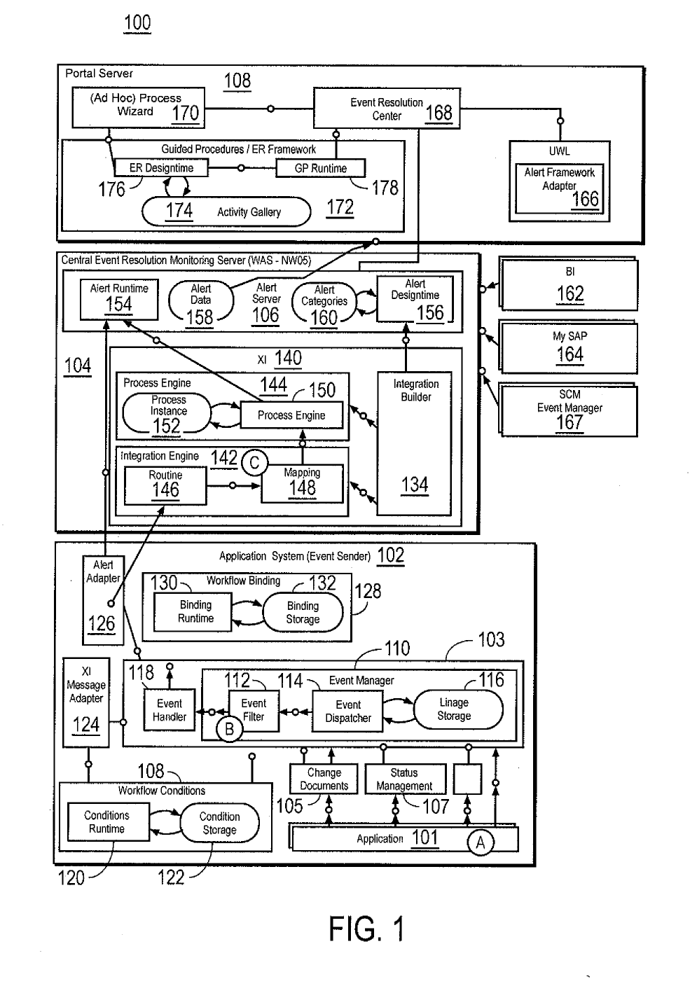

FIG. 1 illustrates a business application monitoring system 100 that aggregates and evaluates monitoring events detected from one or more heterogeneous business applications 101. The business application monitoring system 100 monitors the relevant business issues across each business application 101, normalizes the issues into a standard message protocol, alerts responsible users, and supports the resolution of the business issues. A business issue can be an error in the runtime of a business application 101, an integration problem among two or more business applications 101 or systems, or other problem that affects the proper functioning of the business applications 101. The business application system 100 includes an application system 102, a central event resolution monitoring server 104 including an alert server 106, and a portal server.

Detecting business issues is performed by a local event infrastructure 103 as a part of the application system 102. The local event infrastructure 103 includes an event manager 110 to manage detection of events and mapping the events to exchange infrastructure (XI) messages. The event manager 110 includes an event dispatcher 114 that interprets linkage tables in a linkage storage 116 between events of an application 101 and an event consumer, such as a BAM system. The events are detected by the event manager from a change documents module 105, an application status management module 107, or other module that can generate a message representing a state change of an instance of an application 101 process.

The event manager 110 further includes an event filter 112 that filters events based on conditions, thresholds, parameters, etc., and checks the relevance of the events, based on workflow conditions 108. The event filter 112 then executes an event handler 118 for relevant events. The workflow conditions 108 includes a condition storage 122 that stores one or more conditions of a workflow of the application 101, and which are executed and evaluated by a condition runtime engine 120. As will be discussed below, the conditions can be established via modeling tool such as an integration builder 134.

The event handler 118 translates relevant events into a monitoring event based at least in part on a workflow binding module 128. The workflow binding module 128 includes a binding storage 132 and a binding runtime engine 130 that executes a binding function to bind monitoring events to monitoring processes and business processes, such as a supply chain event of a business application for a supply chain, for example. The event handler 118 also prepares an alert for the monitoring event via an alert adapter 126.

As discussed above, the integration builder 134 is used to define the monitoring events, monitoring processes, process-relevant alert categories, mappings, etc., and to configure each monitoring process. To streamline the setup of the local event infrastructure 103, settings will be made centrally to the greatest extent possible. The integration builder 134 is part of the XI 140. The XI 140 also includes an integration engine 142 and a process engine 144. The integration engine 142 includes a routing module 146 to route XI message-configured monitoring events to the desired message recipient, i.e. the alert server 106. The integration engine 142 also includes a mapping module 148 to map monitoring events to monitoring processes. The monitoring processes are executed by a process engine 150 that is controlled by the integration builder 134, and which generates and runs process instances 152.

The alert server 106 is configured to manage and link alert categories to users. The alert server 106 includes an alert design time module 156 that generates and stores the alert categories 160. The alert server 106 further includes an alert runtime 154 that generates and stores alert data 158 based on messages received either from the process engine 150 or from the alert adapter 126 in the application system 102. Alerts needing or requiring resolution are sent in the form of alert data to an alert framework adapter for resolution in the portal server 108.

Several components can have access to or supply information to the alert server 106. The alert server 106 may be connected with a business intelligence (BI) system 162. BI is adapted to configure key performance indicators for the business application system 100. A role-based set of application tools, such as a MySAP suite of application tools 164, can be used by the alert server 106. Finally, an application-specific event manager 167 can be used to manage events as indicated by the alert server 106.

The portal server 108 provides a portal that includes an event resolution center 168, a graphical user interface in which a user can resolve issues for which alerts have been generated and for which monitoring events and monitoring processes have been created. The event resolution center 168 can be connected to a process wizard 170, which can logically, and in an ad-hoc manner, walk a user through steps to resolve or fix the issue, and can track user actions in such resolutions.

The process wizard 170 and event resolution center 168 use a guided procedures/event resolution framework 172. This framework 172 includes an activity gallery 174 of possible activities that can be undertaken by a user of the portal server. The activities in the activity gallery 174 are used by an event resolution design time module 176, which creates templates of possible resolutions to issues. The activities are also used by a guided procedure runtime module 178 which executes guided procedures for the event resolution center 168. The event resolution design time module 176 can also save new activities to the activity gallery 174 based on feedback from the process wizard 170 for dynamic, self-learning and future use.

The event resolution center 168, guided procedures/event resolution framework 172, and alert framework 166 provide inputs to a process log 107 that supports many different “flavors,” i.e. one or more of a set of identifiable or distinctive characteristics, qualities or attributes, of processes that are tracked by the process log 107. The process log 107 is configured according to monitoring processes established for monitoring events of the business processes of a distributed business application, especially where the business application is formed of heterogeneous computing systems or software.

Not all business object state changes are relevant for event resolution in the BAM system, and whether or not a monitoring event needs a decision is made. This decision is evaluated locally (in the application system, before the monitoring events is transmitted via external communication) to minimize external communication and to provide all application data as decision base for the condition that decides whether the event is event resolution relevant or not.

The event filter performs filtering using a “start condition” that runs on business objects to reduce the delivered events. Alternatively, check-functions allow stopping an event upon an application decision. Each application can create a check-function for each case or use the more generic start conditions. Start conditions are preferably only used for workflow start, but could be adapted to check all kinds of events. These conditions are maintained locally in the application system. Event coupling and condition definition should be done locally in the application system to access the object attributes and available events. In addition, some applications need customizing steps to enable firing events.

The workflow event mechanism already provides a mechanism to reduce the delivered events. The check-functions allow stopping an event upon application decision. Each application can create an own check-function for each case or use the more generic mechanism of so-called start conditions. Start conditions can be used for workflow start, but could be adapted to check all kinds of events. These conditions must be maintained locally in the application system as long the integration repository has no access to the business object metamodel of each application system. The business objects do not exist in the integration builder.

The event coupling and the start conditions are maintained locally in the application system, because only there are all needed repositories (e.g. BOR, Class Library, . . . ) available. That means the event coupling and the condition definition are done locally in the application system to access the object attributes and available events. In addition, some applications need customizing steps to enable firing events.

All data on which a condition is running must be gathered before the condition is executed. Thus, if a condition execution needs more data than available in the process container, the person modeling the process must call several services (using the XI messaging layer via Send and Receive steps) to get the data in the process container. The process can react upon errors during this data enrichment phase and eventually react upon these errors and propagate alert. This makes sure that the condition technology will not implement yet another workflow tool to handle exceptions during a data enrichment phase.

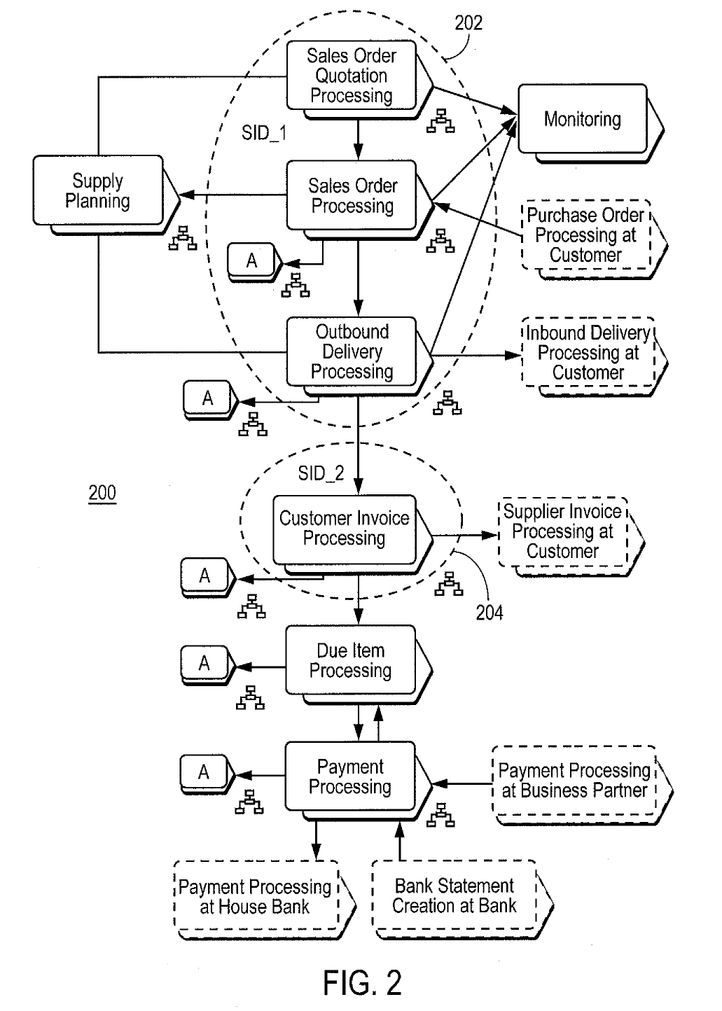

FIG. 2 shows an operational process 200 such as the operation of a supply chain, i.e. the movement of physical objects and the software functions that control and relate to such movement. Operational process 200 can include any number of steps or subprocesses, operating on any number of inputs and producing any number of outputs or events.

Modeling of the operational process involves accounting for monitoring, BAM, and Tracking and Tracing. Monitoring processes in general are always modeled explicitly. There can be more than one monitoring process for each operational process. A monitoring process consists of rules and conditions (e.g. based on measurements) that are not reflected in operational processes. Monitoring processes are also decoupled from operational processes. Objects that are not covered by an operational process (e.g. external status, physical objects, . . . ) can be made visible by a BAM system. Finally, monitoring processes can be created by business experts to reflect a certain aspect that is not reflected in the implementation of an operational process.

For monitoring, specific Monitoring Processes can be targeted for grouping. Accordingly, one or more sets of operational process components are selected based on a grouping. Next, a technical system, denoted according to a system identifier (SID), is assigned to each selected set of process components. For example, as shown in FIG. 2, SID_1 represents a technical system assigned to the process components “Sales Order Quotation Processing, Sales Order Processing, and Outbound Delivery Processing.” SID_2 represents another technical system assigned to the process component “Customer Invoice Processing.” The grouping can be based on any type of criteria or function of the components.

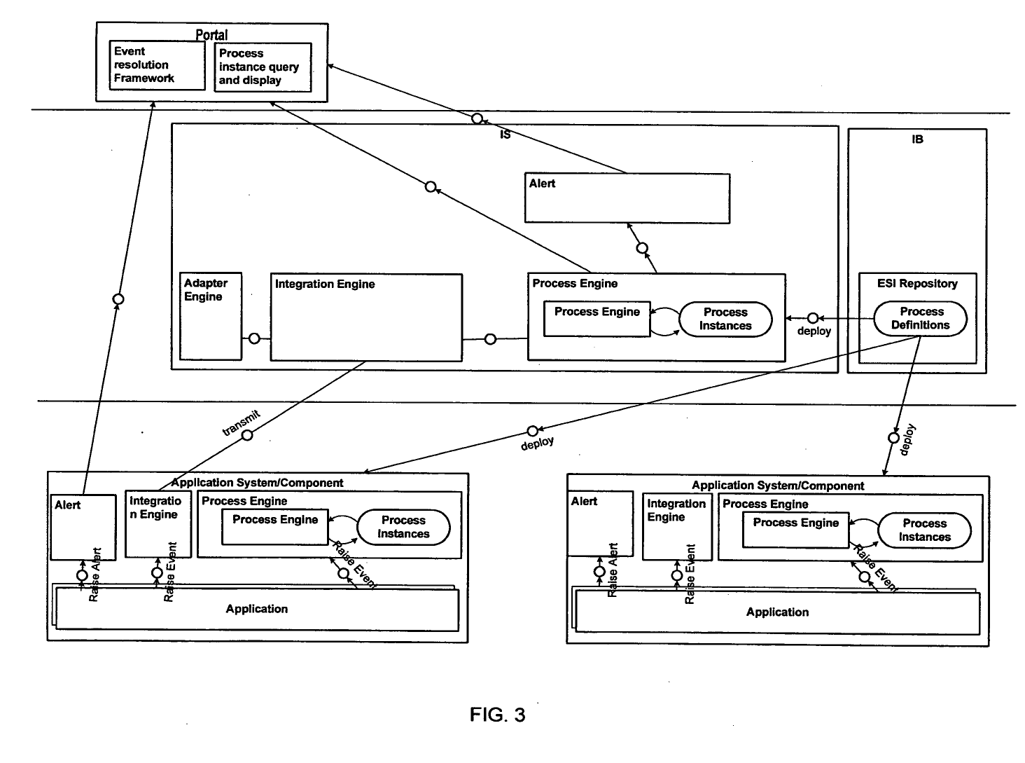

Once assigned to a technical system, an instance of the technical system can be created and deployed, as shown in FIG. 3, to monitor each respective set of operational process components. FIG. 3 illustrates both a centralized and decentralized approach for generating and deploying instances of application components of a business application for a BAM solution. Accordingly, a deployment architecture 300 includes an integration server 302 and an integration builder 304.

The integration builder 304 includes an ESI repository 306 storing a number of process definitions 308, which can be deployed centrally or decentrally. Each deployment includes process instances 310 of the process definitions 308 for execution by a process engine 312 in a process engine instance 314. Each deployment also includes an integration engine 316 for routing and mapping of messages, and an alert module 302 for generating alert messages based on monitoring events. Accordingly, the process instances 310 and process engine 312 can be deployed centrally in an integration server 302 or decentralized as application components 322 or 324.

The application components 322 and 324 are instantiated and mapped to application processes 326. Application components can communicate with the integration server 320 via integration engines 316, as shown with respect to application component 322, or can be substantially decentralized as shown with respect to application component 324.

Alerts about monitoring events are communicated to a portal 328, which includes an event resolution framework 330 having logic for resolving selected monitoring events. The portal 328 also includes a process instance query and display 332 to enable a user to view query results of business processes in the process engine 314.

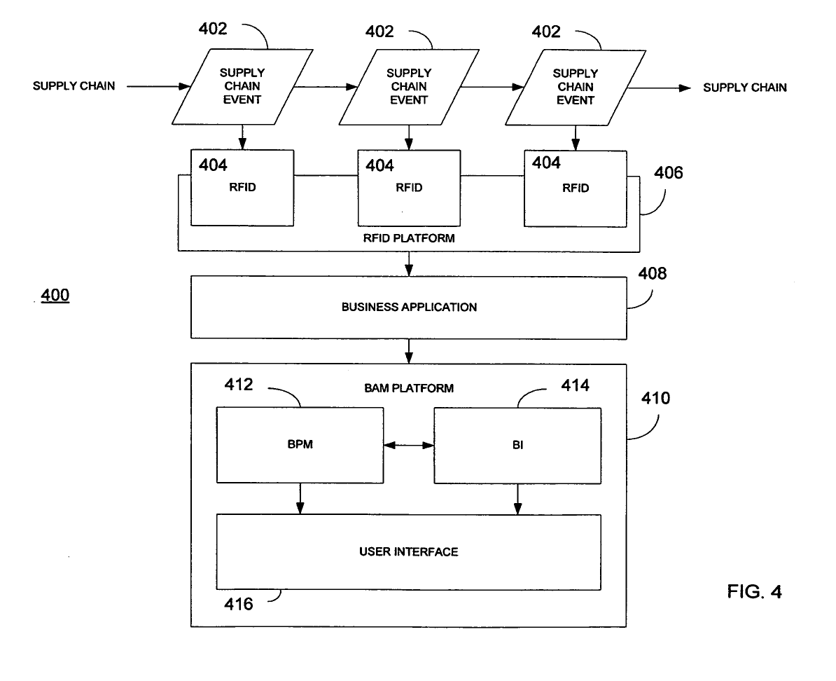

FIG. 4 illustrates a joint tracking and tracing and BAM architecture 400, in which one or more supply chain events 402 (i.e. physical transition or transformation of goods) are performed in a supply chain. The supply chain events 402 represent an activity or state of a physical object that can be tracked and traced by an RFID component 404 of an RFID platform. Each RFID component 404, for example, can be an RFID reader and communication module. The RFID component 404 and/or RFID platform 406 generate tracking and tracing data as inputs for a business application 408, such as a supply chain management application. The business application 408 processes this data from the RFID platform 406 and generates events to be monitored.

The events are detected, collected and monitored by a BAM platform 410, where they are mapped against monitoring events and monitoring processes defined for the business application 408. Relevant events are filtered for transmission, preferably via XI message protocols, to a business process monitoring tool 412, which monitors business processes and executes monitoring processes on those business processes. The business process monitoring tool 412 also communicates with a business intelligence tool 414, which tracks and evaluates business metrics, key performance indicators, and analytical services on the monitoring events.

The business process monitoring tool 412 and the business intelligence tool 414 are accessed and controlled via a user interface 416, preferably in a graphical interface such as a portal. The user interface 416 includes graphical control elements such as one or more dashboards, an event resolution center, and process logs. Accordingly, events that are triggered by business processes from any of a set of heterogeneous business application components can be displayed in the process log in the user interface 416, for efficient tracking and tracing of information associated with the business processes.

Embodiments of the invention and all of the functional operations described in this specification can be implemented in digital electronic circuitry, or in computer software, firmware, or hardware, including the structures disclosed in this specification and their structural equivalents, or in combinations of them. Embodiments of the invention can be implemented as one or more computer program products, i.e., one or more modules of computer program instructions encoded on a computer readable medium, e.g., a machine readable storage device, a machine readable storage medium, a memory device, or a machine-readable propagated signal, for execution by, or to control the operation of, data processing apparatus.

The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of them. A propagated signal is an artificially generated signal, e.g., a machine-generated electrical, optical, or electromagnetic signal, that is generated to encode information for transmission to suitable receiver apparatus.

A computer program (also referred to as a program, software, an application, a software application, a script, or code) can be written in any form of programming language, including compiled or interpreted languages, and it can be deployed in any form, including as a stand alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to, a communication interface to receive data from or transfer data to, or both, one or more mass storage devices for storing data, e.g., magnetic, magneto optical disks, or optical disks.

Moreover, a computer can be embedded in another device, e.g., a mobile telephone, a personal digital assistant (PDA), a mobile audio player, a Global Positioning System (GPS) receiver, to name just a few. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, embodiments of the invention can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the invention can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the invention, or any combination of such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

Certain features which, for clarity, are described in this specification in the context of separate embodiments, may also be provided in combination in a single embodiment. Conversely, various features which, for brevity, are described in the context of a single embodiment, may also be provided in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Particular embodiments of the invention have been described. Other embodiments are within the scope of the following claims. For example, the steps recited in the claims can be performed in a different order and still achieve desirable results. In addition, embodiments of the invention are not limited to database architectures that are relational; for example, the invention can be implemented to provide indexing and archiving methods and systems for databases built on models other than the relational model, e.g., navigational databases or object oriented databases, and for databases having records with complex attribute structures, e.g., object oriented programming objects or markup language documents. The processes described may be implemented by applications specifically performing archiving and retrieval functions or embedded within other applications.

What is claimed:

1. A business supply chain monitoring system comprising:
a computer system implementing a business application comprising a number of monitoring events and a number of monitoring processes corresponding to a number of supply chain events of the supply chain;
an RFID platform having one or more RFID readers, at least one RFID reader being assigned to a supply chain event to generate tracking and tracing data for the number of supply chain events; and
a business activity monitoring platform that maps the tracking and tracing data for the number of supply chain events against a set of the number of monitoring events and the number of monitoring processes defined for the business application, to monitor performance of the supply chain and business application.

2. A business supply chain monitoring system in accordance with claim 1, wherein the business activity monitoring platform further includes a business process monitoring tool to monitor business processes of the business application.

3. A business supply chain monitoring system in accordance with claim 2, wherein the business process monitoring tool is further configured to execute the set of the number of monitoring processes on the business processes of the business application.

4. A business supply chain monitoring system in accordance with claim 1, wherein the business activity monitoring platform further includes a business intelligence tool that tracks and evaluates business metrics, key performance indicators, and analytical services on the set of the number of monitoring events.

5. A business supply chain monitoring system in accordance with claim 4, wherein the business intelligence tool communicates to a business process monitoring tool that monitors business processes of the business application.

6. A business supply chain monitoring system in accordance with claim 1, further comprising a user interface generated by the business activity monitoring platform to control functions of the business activity monitoring platform.

7. A business supply chain monitoring system comprising:
a server comprising a business activity monitoring platform that maps, against monitoring events and monitoring processes defined for a business application that controls a supply chain, tracking and tracing data provided by an RFID platform for a number of supply chain events of the supply chain.

8. A business supply chain monitoring system in accordance with claim 7, wherein the RFID platform includes one or more RFID readers, at least one RFID reader being assigned to one of the supply chain events to generate the tracking and tracing data.

9. A business supply chain monitoring system in accordance with claim 7, wherein the business application is hosted on a computer system that is in communication with the RFID platform.

10. A business supply chain monitoring system in accordance with claim 7, wherein the business activity monitoring platform further includes a business intelligence tool that tracks and evaluates business metrics, key performance indicators, and analytical services on the set of the monitoring events.

11. A business supply chain monitoring system in accordance with claim 10, wherein the business intelligence tool communicates to a business process monitoring tool that monitors business processes of the business application.

12. A business supply chain monitoring system in accordance with claim 11, wherein the business process monitoring tool is further configured to execute the set of the number of monitoring processes on the business processes of the business application.

13. A business supply chain monitoring method comprising:
executing a business application that comprises a number of monitoring events and a number of monitoring processes corresponding to a number of supply chain events of the supply chain;
generating tracking and tracing data for the number of supply chain events with one or more RFID readers of an RFID platform; and
mapping the tracking and tracing data for the number of supply chain events against a set of the number of monitoring events and the number of monitoring processes defined for the business application, to monitor performance of the supply chain and business application.

14. A business supply chain monitoring method in accordance with claim 13, further comprising filtering the number of monitoring events and number of monitoring processes to generate the set of the number of monitoring events and number of monitoring processes.
